(19) United States
(12) Patent Application Publication
(10) Pub. No.: US 2024/0430704 A1
(43) Pub. Date: Dec. 26, 2024

(54) ENVIRONMENTAL ELECTROMAGNETIC PROFILING

(71) Applicant: QUALCOMM Incorporated, San Diego, CA (US)

(72) Inventors: Marwen Zorgui, San Diego, CA (US); Srinivas Yerramalli, San Diego, CA (US); Mohammed Ali Mohammed Hirzallah, San Diego, CA (US)

(21) Appl. No.: 18/338,333

(22) Filed: Jun. 20, 2023

(51) Int. Cl. H04W 24/02; H04B 17/318; H04B 17/336

(52) U.S. Cl. CPC H04W 24/02; H04B 17/328; H04B 17/336

(57) ABSTRACT

This disclosure provides systems, methods, and devices for wireless communication that support a sensing operation. In a first aspect, a method of wireless communication includes transmitting a configuration associated with a sensing operation. The method also includes receiving, from a network entity, a report based on the sensing operation performed by the network entity and that indicates an electromagnetic profile associated with an environment. Other aspects and features are also claimed and described.

### TECHNICAL FIELD

Aspects of the present disclosure relate generally to sensing systems, and more particularly, to performing a sensing operation, such as a sensing operation for an environment and that is associated with a profile of the environment. Some features may enable and provide enhanced tracking of objects in an environment, conservation or efficient use of power and computational resources, or a combination thereof.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

Tracking or identification of objects in an environment, such as objects in the environment that are stationary or approximately stationary, is challenging yet important. For example, a warehouse may contain multiple objects, including humans or automated guided vehicles (AGVs), that operate within the warehouse. An object in the environment that has an approximately zero velocity may be considered to be an approximately stationary object. While a placement of these objects within the warehouse may change over time, such as due to the movement of people or the movement of AGVs within the warehouse, the velocities of these objects may be sufficiently low (e.g., close to zero) so that these objects are difficult to track. Additionally, some objects placed within the warehouse, such as certain robots, may be stationary but exhibit particular movements during particular timeframes. For instance, a manufacturing robot may stationary, but a mechanical arm of the manufacturing robot may move. Accordingly, such a manufacturing robot may be difficult to track within the warehouse. Accurately tracking objects within an environment, such as within a warehouse, may promote a safe working environment while maintaining operational efficiency.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for supporting one or more sensing operations includes initiating transmission of a configuration associated with a sensing operation. The method also includes receiving, from a network entity, a report based on the sensing operation performed by the network entity. The report indicates an electromagnetic profile associated with an environment.

In an additional aspect of the disclosure, a network configured to support one or more sensing operations includes at least one processor and a memory coupled to the at least one processor. The at least one processor is configured to initiate transmission of a configuration associated with a sensing operation. Additionally, the at least one processor is configured to receive, from a network entity, a report based on the sensing operation performed by the network entity. The report indicates an electromagnetic profile associated with an environment.

In an additional aspect of the disclosure, an apparatus for supporting one or more sensing operations includes means for initiating transmission of a configuration associated with a sensing operation. The apparatus further includes means for receiving, from a network entity, a report based on the sensing operation performed by the network entity. The report indicates an electromagnetic profile associated with an environment.

In an additional aspect of the disclosure, a non-transitory computer-readable medium stores instructions that, when executed by a processor, cause the processor to perform operations associated with a sensing operation. The operations include initiating transmission of a configuration associated with a sensing operation. The operations further include receiving, from a network entity, a report based on the sensing operation performed by the network entity. The report indicates an electromagnetic profile associated with an environment.

In one aspect of the disclosure, a method for supporting one or more sensing operations includes receiving a configuration associated with a sensing operation. The method also includes initiating transmission of a report based on the sensing operation performed by the network entity. The report indicates an electromagnetic profile associated with an environment.

In an additional aspect of the disclosure, a network configured to support one or more sensing operations includes at least one processor and a memory coupled to the at least one processor. The at least one processor is configured to initiate transmission of a configuration associated with a sensing operation. Additionally, the at least one processor is configured to receive, from a network entity, a report based on the sensing operation performed by the network entity. The report indicates an electromagnetic profile associated with an environment.

In an additional aspect of the disclosure, an apparatus for supporting one or more sensing operations includes means for receiving a configuration associated with a sensing operation. The apparatus further includes means for initiating transmission of a report based on the sensing operation performed by the network entity. The report indicates an electromagnetic profile associated with an environment.

In an additional aspect of the disclosure, a non-transitory computer-readable medium stores instructions that, when executed by a processor, cause the processor to perform operations associated with a sensing operation. The operations include receiving a configuration associated with a sensing operation. The operations further include initiating transmission of a report based on the sensing operation performed by the network entity. The report indicates an electromagnetic profile associated with an environment.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 shows a diagram illustrating an example sensing system that supports performance of a sensing operation in an environment according to one or more aspects.

FIG. 4 shows a diagram illustrating an example of a result of a sensing operation performed in an environment according to one or more aspects.

FIG. 5 shows a diagram illustrating an example of a result of a sensing operation performed in an environment according to one or more aspects.

FIGS. 6A-6C show diagrams illustrating an example of a sensing operation performed in an environment according to one or more aspects.

FIG. 7 show a diagram illustrating an example technique that supports performance of a sensing operation in an environment according to one or more aspects.

FIG. 8 is a flow diagram illustrating an example process that supports performance of a sensing operation in an environment according to one or more aspects.

FIG. 9 is a block diagram of an example core network that supports performance of a sensing operation in an environment according to one or more aspects.

FIG. 10 is a flow diagram illustrating an example process that supports performance of a sensing operation in an environment according to one or more aspects.

FIG. 11 is a block diagram of an example network entity that supports performance of a sensing operation in an environment according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support performance of a sensing operation in an environment. For example, the present disclosure describes configuring a network entity to perform a sensing operation. To illustrate, the network entity may receive a configuration that indicates to perform a sensing operation, a format of a report based on the sensing operation, or a combination thereof. For example, the format of the report may include or correspond to an indication to cause the network entity to aggregate data obtained over one or more beams associated with a transmitted scan signal, and generating a report corresponding to data associated with each beam of a transmitted scan signal. Additionally, or alternatively, the network entity may be configured to generate a report based on the sensing operation. The report may include or indicate an electromagnetic profile of an environment, such as a radio frequency (RF) profile of the environment, a physical layout of the environment, or a combination thereof. The network entity is configured to transmit the report to a core network. The core network is configured to receive the report and is further configured to generate an electromagnetic profile of the environment based on the report. Additionally, the core network may be configured to identify or track an object, such as a stationary object or a mobile object, in the environment based on the electromagnetic profile. In some implementations, the core network may receive multiple reports over time and update the electromagnetic profile of the environment based on the multiple reports. In some such implementations, updating the electromagnetic profile enables the core network to identify or track the object.

Particular implementations of the subject matter described in this disclosure may be implemented to realize one or more of the following potential advantages or benefits. In some aspects, the present disclosure provides techniques for supporting performance of a sensing operation in an environment. The techniques described provide enhanced tracking of objects, especially stationary objects, within an environment, while conserving power and computational resources. For example, by aggregating data over a plurality of beams, computational resources and associated power may be conserved, since the associated reports generally contain less data than reports that include data associated with each beam of a transmitted scan signal. Additionally, in situations in which greater accuracy and precision of an electromagnetic profile of an environment are beneficial, the network entity may switch to a mode in which data generated from sensing operations are reported per beam rather than aggregated.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHZ) and FR2 (24.25 GHZ-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHZ, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHZ, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

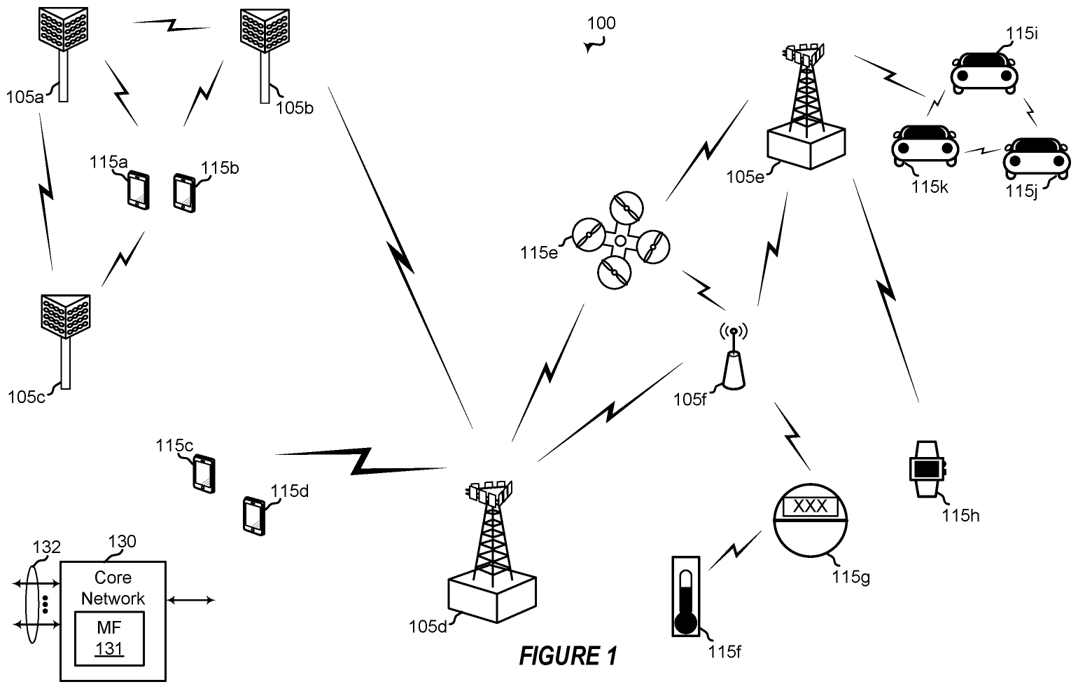

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115c-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105c. Additionally, V2V mesh network may include or correspond to a vehicle-to-everything (V2X) network between UEs 115i-115k and one or more other devices, such as UEs 115x, 115y.

Base stations 105 may communicate with a core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

Core network 130 may provide user authentication, access authorization, tracking. Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to a management function (MF) 131, such as a Location Management Function (LMF), a Sensing Management Function (SnMF), or an Access and Mobility Management Function (AMF), which is an entity in the 5G Core Network (5GC) supporting various functionality, such as managing support for different location services for one or more UEs. The SnMF may be configured to manage support for sensing operations for one or more sensing operations or sensing services for one or more devices, such as one or more UEs 115, one or more base stations 105, one or more TRPs, or a combination thereof. For example the SnMF may include one or more servers, such as multiple distributed servers. Base stations 105 may forward sensing messages to the SnMF and may communicate with the SnMF via a NR Positioning Protocol A (NRPPa). The SnMF is configured to control sensing parameters for UEs 115 and the SnMF can provide information to the base stations 105 and UE 115 so that action can be taken at UE 115, base station 105, or another device. The LMF may include one or more servers, such as multiple distributed servers. Base stations 105 may forward location messages to the LMF and may communicate with the LMF via a NR Positioning Protocol A (NRPPa). The LMF is configured to control the positioning parameters for UEs 115 and the LMF can provide information to the base stations 105 and UE 115 so that action can be taken at UE 115. In some implementations, UE 115 and base station 105 are configured to communicate with the LMF via the AMF.

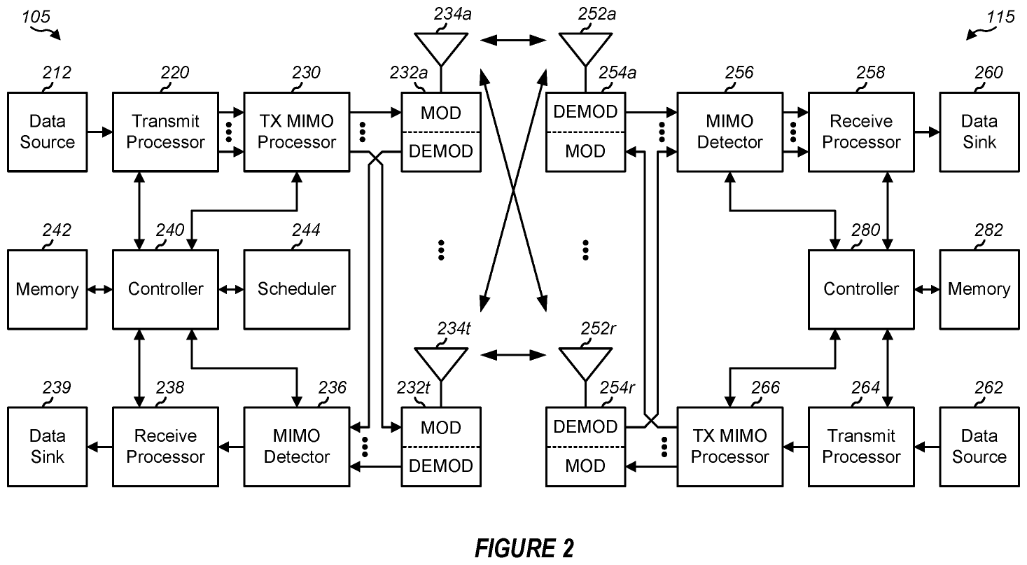

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

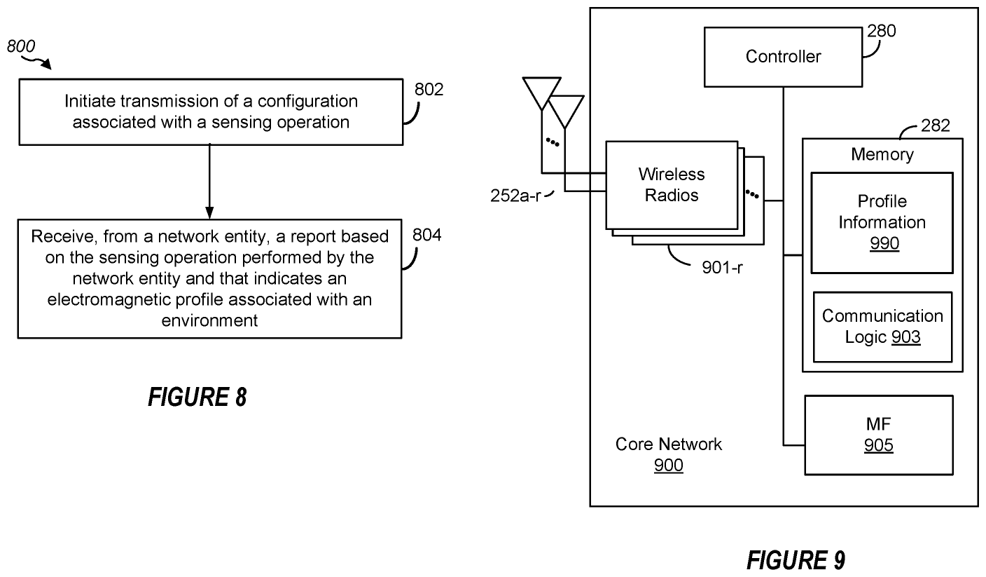

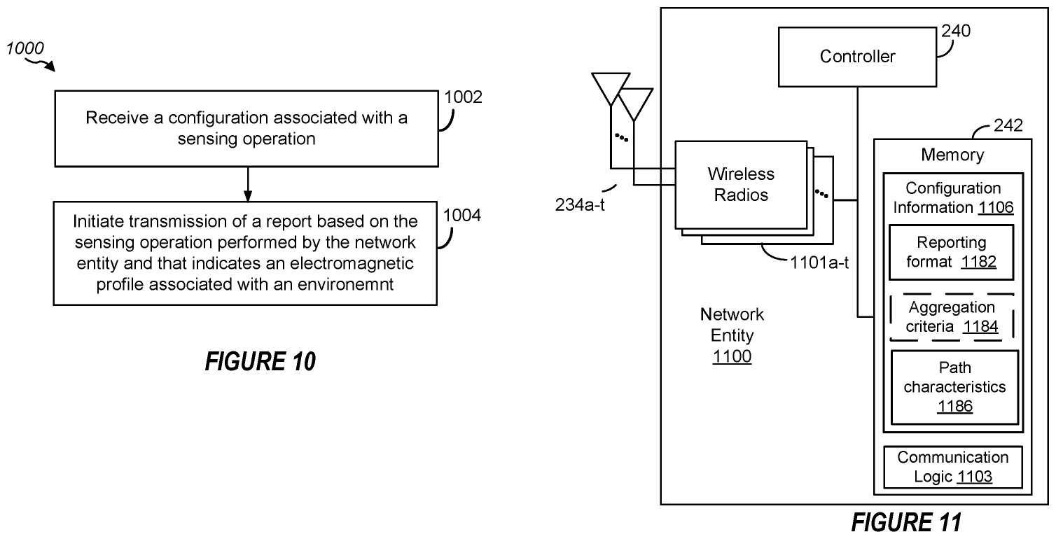

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in or described with reference to FIGS. 8 and 10, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

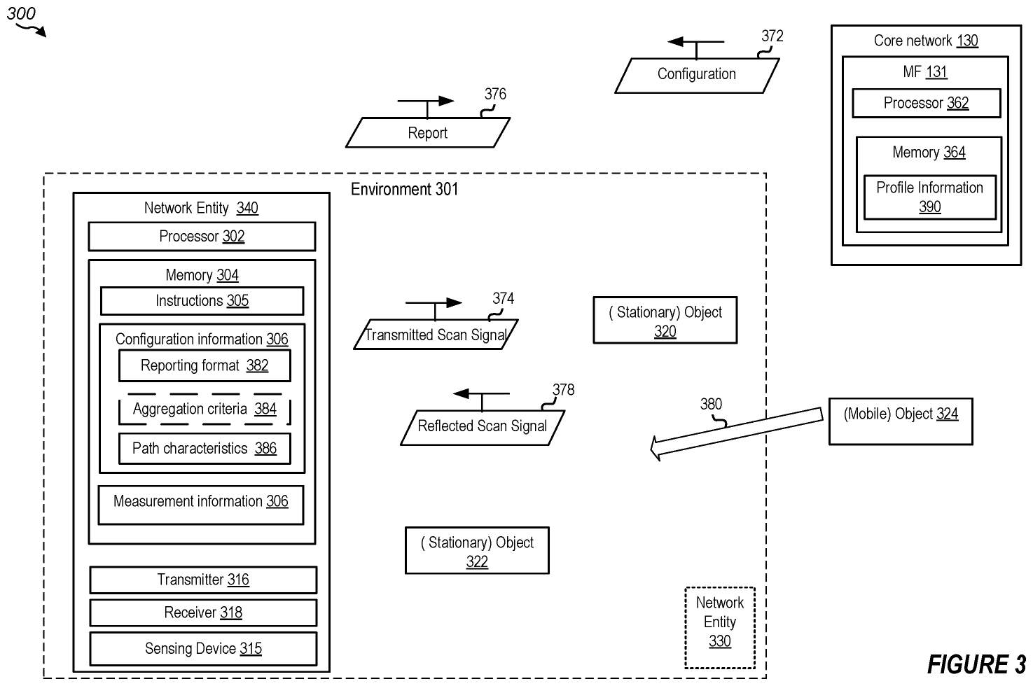

FIG. 3 is a block diagram of an example sensing system 300 that supports performance of a sensing operation in environment 301 according to one or more aspects. In some examples, sensing system 300 may implement aspects of wireless network 100. Sensing system 300 may include core network 130 and network entity 340. Additionally, sensing system 300 may include a plurality of network entities, such as network entity 330, in addition to network entity 340.

In some implementations, one or more network entities 330, 340 may be located within an environment 301. Environment 301 may include or correspond to any space, such as an enclosed space. For instance, environment 301 may include or correspond to a warehouse. Environment 301 may also include, or have located therein, one or more objects, such as a plurality of representative objects 320-324. Objects 320-324 may be stationary, mobile, or a combination thereof. For example, objects 320, 322 may be stationary and object 324 may be mobile. Core network 130, network entity 340, network entity 330, or any combination thereof, may be configured to support performance of a sensing operation in environment 301. The sensing operation may be configured to track one or more of objects 320-324 in environment 301.

Network entity 340 may include a variety of components (such as structural, hardware components) used for carrying out one or more functions described herein. For example, these components may include one or more processors 302 (hereinafter referred to collectively as “processor 302”), one or more memory devices 304 (hereinafter referred to collectively as “memory 304”), one or more transmitters 316 (hereinafter referred to collectively as “transmitter 316”), and one or more receivers 318 (hereinafter referred to collectively as “receiver 318”). In some implementations, network entity 340 may include an interface (e.g., a communication interface) that includes transmitter 316, receiver 318, or a combination thereof. Processor 302 may be configured to execute instructions 305 stored in memory 304 to perform the operations described herein. In some implementations, processor 302 includes or corresponds to one or more of receive processor 238, transmit processor 220, and controller 240, and memory 304 includes or corresponds to memory 242.

Memory 304 includes or is configured to store instructions 305, configuration information 306, measurement information 387, or a combination thereof. Instructions 305 may include processor-readable code, program code, one or more software instructions, or the like, as illustrative, non-limiting examples. Instructions 305, when executed by processor 302, may implement the functionality described herein. Configuration information 306 may include or indicate a configuration associated with a sensing operation of the environment, a configuration of a report based on a sensing operation, or a combination thereof.

The sensing operation of the one or more sensing operations may include initiating, by processor 302 of network entity 340, transmission of one or more transmitted scan signals 374 (hereinafter referred to collectively as “transmitted scan signal 374”) within environment 301. Transmitted scan signal 374 may include or correspond to a radio frequency (RF) signal, a microwave signal, an infrared (IR) signal, or to any electromagnetic wave. Transmitted scan signal 374 may impinge upon a surface of one or more objects present in environment 301 (e.g., object 320-324). Accordingly, transmitted scan signal 374 may be reflected by the surface of the one or more objects, thereby generating one or more reflected scan signals 378 (hereinafter referred to collective as “reflected scan signal 378”). In some implementations, a plurality of antennas of transmitter 316 may generate beams or resources associated with a transmitted scan signal 374. Each beam or resource may impinge upon an object of one or more objects, such as objects 320-324 in environment 310, thereby generating, for each beam that is reflected off of a surface of an object, a reflected beam, corresponding to reflected scan signal 378.

A sensing operation may include or correspond to a monostatic sensing operation or a bistatic sensing operation. In a monostatic sensing operation, reflected scan signal 378 may be received by receiver 318 of network entity 340, while in a bistatic sensing operation, reflected scan signal 378 may be received by a receiver of another network entity, such as network entity 330. Accordingly, transmitted scan signal 374 and reflected scan signal 378 may define a path from a transmit network entity 340 to an object, such as object 320-324 within environment 301, and then to a receive network entity, which may be network entity 340, a second network entity (e.g., network entity 330), or both.

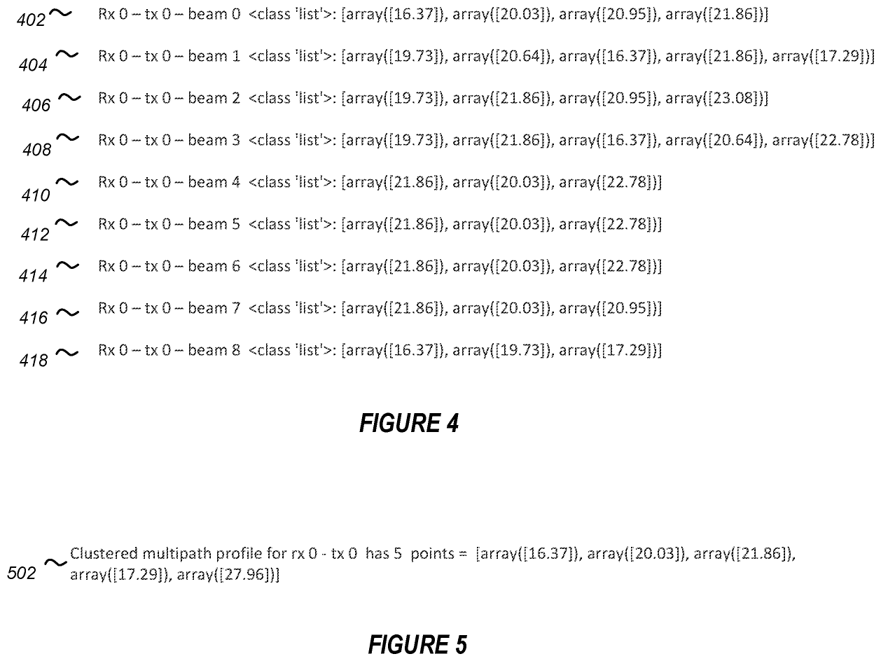

Configuration information 306 may include or indicate reporting format 382, aggregation criteria 384, path characteristics 386, or a combination thereof. Reporting format 382 may indicate a format of report 376, generated by processor 302 of network entity 340 based on the one or more sensing operations. For instance, reporting format 382 may indicate whether processor 302 of network entity 340 is to report data associated with each resource of a sensing operation per resource, as described more fully with reference to FIG. 4, or whether the data is to be aggregated across a plurality of resources, as described more fully with reference to FIG. 5.

Aggregation criteria 384 indicate one or more parameters for aggregating data associated with a plurality of paths in report 376. For instance, aggregation criteria 384 may indicate which paths are to be clustered such that data associated with these paths is to be aggregated. Path characteristics 386 indicate characteristics that data associated with a path is to satisfy so that such data may be included in report 376. For example, path characteristics 386 may include or correspond to a threshold associated with a reference signal receive power (RSRP), an RSRP per path (RSRPP), a signal to noise ratio (SNR), or a combination thereof. The RSRP per path may include or correspond to a RSRP value associated with each path. For example, characteristics 386 may include a threshold value associated with each RSRPP. As another example, path characteristics 386 may include or correspond to spectral characteristics such that data corresponding to paths that satisfy the spectral characteristics are aggregated. These spectral characteristics may include or correspond to a distance between network entity 340 and an object defined by a path, an angle of a path relative to network entity 340, or a combination thereof.

Measurement information 387 may include or correspond to data obtained from performance of a sensing operation. The receive network entity, such as processor 302 of network entity 340 in a monostatic sensing operation or a processor of network entity 330 in a bistatic sensing operation, may be configured to determine a round trip time (RTT) of scan signal 374, which may be converted to a distance, representing a distance separating network entity 340 from the object (e.g., object 320-324). Additionally, processor 302 of network entity 340 may determine an angle between transmitted scan signal 374 and one or more objects, such as objects 320-324, in environment 301. Thus, measurement information 387 may include or correspond to RTT measurements, distance measurements, angle measurements, or any combination thereof.

Transmitter 316 is configured to transmit transmitted scan signal 374. Additionally, transmitter 316 may be configured to transmit reference signals, synchronization signals, control information, data, or any combination thereof to one or more other devices. Receiver 318 may be configured to receive reflected scan signal 378, reference signals, control information, data, or any combination thereof from one or more other devices. For example, transmitter 316 may transmit transmitted scan signal 374, signaling, control information, data, or any combination thereof to, and receiver 318 may receive reflected scan signal 378, signaling, control information, data, or any combination thereof from, core network 130.

In some implementations, transmitter 316 and receiver 318 may be integrated in one or more transceivers. Additionally or alternatively, transmitter 316 or receiver 318 may include or correspond to one or more components of base station 105, UE 115, or both as described with reference to FIGS. 1 and 2.

In some implementations, network entity 340 may include one or more antenna arrays. The antenna array may include multiple antenna elements configured to perform wireless communications with other devices, such as core network 130, to perform one or more sensing operations, or a combination thereof. In some implementations, the antenna array may be configured to perform wireless communications, sensing operations, or both using different beams, also referred to as antenna beams. The beams may include scan signal beams, TX beams, RX beams, or a combination thereof. For example, the beams may include or correspond to transmitted scan signal 374, reflected can signal 378, or both. To illustrate, the antenna array may include multiple independent sets (or subsets) of antenna elements (or multiple individual antenna arrays), and each set of antenna elements of the antenna array may be configured to communicate, to perform a sensing operation, or both using a different respective beam that may have a different respective direction than the other beams. For example, a first set of antenna elements of the antenna array may be configured to communicate, to perform a sensing operation, or both via a first beam having a first direction, and a second set of antenna elements of the antenna array may be configured to communicate, to perform a sensing operation, or both via a second beam having a second direction. In other implementations, the antenna array may be configured to communicate, to perform a sensing operation, or both via more than two beams. Alternatively, one or more sets of antenna elements of the antenna array may be configured to concurrently generate multiple beams, for example using multiple radio frequency (RF) chains of base station 105, UE 115, or both. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate, to perform a sensing operation, or both using a different respective beam.

In some implementations, UE 115 may include a sensing device configured to perform one or more sensing operations. The one or more sensing operations may include a monostatic sensing operation, a bistatic sensing operation, or a combination thereof. In some implementations, sensing device includes transmitter 316, receiver 318, a communication interface, or a combination thereof. For example, the sensing device may include both transmitter 316 and receiver 318, include transmitter 316 but not receiver 318, or may include receiver 318 but not transmitter 316. In some implementations, network entity 340 is a 5G-capable UE, a 6G-capable UE, or a combination thereof.

Network entity 330 may include one or more components similar to or the same as described herein with reference to network entity 340. Additionally, or alternatively, network entity 330 may be configured to perform one or more operations as described herein with reference to network entity 340. While FIG. 3 depicts only one additional network entity 330 in addition to network entity 340, sensing system 300 may include multiple network entities in addition to network entity 340. Each of the multiple network entities may be include one or more components or may be configured to perform one or more operations as described herein with reference to network entity 340.

Core network 130 may include a variety of components (such as structural, hardware components) used for carrying out one or more functions described herein. For example, these components may include MF 131, which itself may include one or more processors 362 (hereinafter referred to collectively as “processor 362”), one or more memory devices 364 (hereinafter referred to collectively as “memory 364”), or both. In some implementations, core network 130 includes or is a server, such as a single server, a distributed server, or a cloud server, as illustrative, non-limiting examples.

In some implementations, core network 130 may include an interface (not depicted), such as a communication interface, that includes a transmitter, a receiver, or a combination thereof. The communication interface may be configured to transmit and receive data. For example, the communication interface may be configured to transmit configuration 372 and to receive report 376, as described herein. The communication interface may be a wired communication interface (e.g., Ethernet), a wireless communication interface, or combination thereof, as illustrative, non-limiting examples.

Processor 362 may be configured to execute instructions stored in memory 364 to perform the operations described herein. In some implementations, processor 362 includes or corresponds to one or more of receive processor 258, transmit processor 264, and controller 280, and memory 364 includes or corresponds to memory 282.

Memory 364 is configured to store profile information 390. Profile information 390 may include or correspond to an electromagnetic profile of an environment, such as environment 301. For instance, the profile of the environment may include or correspond to a radio frequency (RF) profile of environment 301. In implementations, MF 131 may include or correspond to a an AMF, an LMF, an SnMF, or any combination thereof.

Core network 130 may include one or more components as described herein with reference to core network 130 of FIG. 1. In some implementations, core network 130 is 5G-capable, 6G-capable, or a combination thereof.

Objects 320-324 may be stationary or mobile. For instance, objects 320, 322 may be stationary, while object 324 may be mobile. A stationary object, such as object 320 or 322, may be an object within an environment, such as environment 301, that has a zero velocity or an approximately zero velocity over a period of time. For instance, a manufacturing robot that does not change its location over a period of time may be a stationary object. Objects 320-324 may include or correspond to any material object, such as a person, an AGV, a robot, or the like. Mobile object 324 may be configured to periodically enter into environment 301 or exit environment 301, or move within environment 301.

In some implementations, sensing system 300 implements a 5G NR network. For example, sensing system 300 may include multiple network entities 330, 340, multiple 5G-capable UEs 115 and multiple 5G-capable base stations 105, such as UEs and base stations configured to operate in accordance with a 5G NR network protocol such as that defined by the 3GPP. In some other implementations, sensing system 300 implements a 6G network.

During operation of sensing system 300, core network 130 may generate and transmit configuration 372. Network entity 340 receives configuration 372 and performs a sensing operation based on configuration 372. The sensing operation includes transmitting transmitted scan signal 374 within environment 301. Transmitted scan signal 374 may impinge upon one or more of objects 320-324 present in environment 301. A surface of the one or more objects 320-324 may reflect a portion of transmitted scan signal 374 as reflected scan signal 378. In a monostatic sensing operation, network entity 340 may receive reflected scan signal 378. In a bistatic sensing operation, network entity 330 may receive reflected scan signal 378.

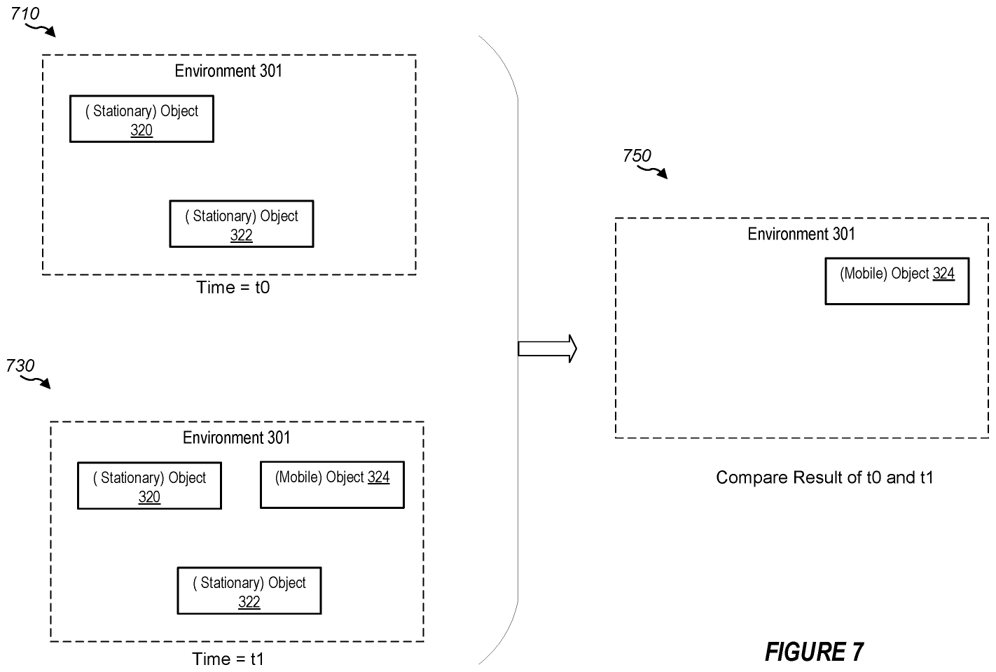

Based on the received reflected scan signal 378, network entity 340 may generate measurement information 387. Subsequently, network entity 340 may generate report 376 based on measurement information 387 and may transmit report 376 to other devices, such as to core network 130. Core network 130 may be configured to receive report 376 and generate profile information 390 corresponding to an electromagnetic profile of environment 301. Further, core network 130 may receive multiple reports (e.g., multiple of report 376) over time and update profile information 390 based on the multiple reports. Additionally, or alternatively, for each subsequent or new report 376 received, core network 130 may generate new or additional profile information 390 and may compare the new or additional profile information 390 to profile information 390 generated at prior instances of time, as explained more fully with reference to FIG. 7.

By repeatedly performing sensing operations at different instances of time, network entity 340 may be configured to generate a plurality of reports, such as report 376. Each report 376 of the plurality of reports may include or correspond to an electromagnetic profile or electromagnetic signature of environment 301 at instances of time at which each sensing operation was performed and that corresponds to report 376. For example, at a first instance of time during which a first sensing operation is performed, environment 301 may include objects 320, 322. However, at a second instance of time during which a second sensing operation is performed, environment 301 may include object 324 which entered environment 301, thereby changing an electromagnetic profile of environment 301. Report 376 generated at the first instance of time captures a presence of objects 320, 322 in environment 301, while report 376 generated at the second instance of time captures a presence of object 324 that entered environment 301 during or prior to the second instance of time but was not present in environment 301 during the first instance of time.

Core network 130 may be configured to receive report 376 and may be configured to identify a target within environment 301 based on report 376. For example, core network 130 may be configured to compare a first report and a second report of a plurality of reports 376. Based on the comparing the reports 376, processor 362 may be configured to identify a target in environment 301. The target may include or correspond to one or more objects (e.g., objects 320-324) within environment 301 including any stationary object (e.g., object 320, 324), any mobile object 324, or a combination thereof. Memory 364 of core network 130 may be configured to store the electromagnetic signature or electromagnetic profile of environment 301, comparisons of the foregoing, or a combination thereof, denoted, in FIG. 3, as profile information 390.

In some implementations, a sensing management function (e.g., 131), such as core network 130, configures a node, such as network entity 330 or 340, to report an electromagnetic signature or electromagnetic profile of space, such as environment 301. Network entity 330, 340 may be a TRP or a UE. For instance, network entity 330 may be a UE, while network 340 may be a TRP. Conversely, network entity 330 may be a TRP, and network entity 340 may be a UE. Alternatively, network entity 330 and network entity 340 both may be UEs or may both be TRPs.

In some implementations, for each sensing operation, network entity 340 may initiate transmission, to core network 130, of report 376, that is generated based on the sensing operation and that indicates an electromagnetic profile associated with an environment. Thus, for N sensing operations, network entity 340 may transmit, to core network 130, N reports, where N is a positive integer. Each of the N reports may indicate a timestamp corresponding to a timeframe during which the sensing operation associated with the report was performed, such as a time the sensing operation began, a time the report was generated, etc. However, in other implementations, network entity 340 may perform a plurality of sensing operations and may transmit report 376, to core network 130, that combines the results of the plurality of the sensing operations into a single report. The single report may correspond to an electromagnetic profile of an environment generated over a period of time during which the plurality of the sensing operations were performed. In some implementations, the combined report may include or indicate a number of reports that were combined, a timestamp for one or more of the reports that was combined, a time period during with the plurality of sensing operations were performed, a timestamp associated with generation of the combined results, or a combination thereof.

In some implementations, a configuration, received by a network entity, may include a reporting format, corresponding to reporting format 382. For example, network entity 340 may receive configuration 372 that includes or indicates reporting format 382. In a first implementation, the reporting format may indicate reporting per resource, such as reporting for each beam associated with transmitted scan signal 374. In a second implementation, the reporting format may indicate aggregated reporting across a plurality of resources, such as aggregating data generated by a cluster of beams associated with transmitted scan signal 374.

In the first implementation, the network entity, such as network entity 340, may report data corresponding to any detected objects per beam, as depicted with reference to FIG. 4. As shown in FIG. 4, a transmitter-receiver pair, such as transmitter 316 (e.g., TX₀) and receiver 318 (e.g., RX₀) of network entity 340, performing a monostatic sensing operation, or transmitter 316 of network entity 340 and a receiver of network entity 330, performing a bistatic sensing operation, may employ nine beams 402-418 of transmitted scan signal 374. For each beam, 402-418, in which one or more objects (e.g., objects 320-324) are detected, network entity may generate report 376, which network entity 340 may transmit to core network 130. For example, through beam 402 (e.g., transmitted scan signal 374, reflected scan signal 378), four objects have been detected at a distance of 16.37 meters (m), 20.03 m, 20.95 m, and 21.86 m away from network entity 340. Accordingly, network entity 340 may generate report 376 that includes data corresponding to beam 402. Similarly, network entity 340 may generate an additional report 376 that includes data associated with beam 404. Hence, network entity 340 may generate reports that include data associated with each beam 402-418.

Alternatively, in the first implementation, a network entity, such as network entity 340, may differentially report per beam. In differential reporting, network entity 340 may identify a plurality of paths per resource. Subsequently, network entity 340 may compare paths of the plurality of paths. Thereafter, network entity 340 may identify any unique paths among the paths based on the comparison of paths and may include data in report 376 that corresponds to the unique paths.

For instance, if a first beam of transmitted scan signal 374 transmitted by network entity 340 during a first sensing operation identifies ten paths and a second beam of transmitted scan signal 374 transmitted by network entity 340 during a second sensing operation identifies 12 paths in which ten of the 12 paths are identical to the ten paths identified during the first sensing operation, then network entity 340 may include, in a first report 376 associated with the second sensing operation, data corresponding to the two unique paths. Additionally, network entity 340 may include in a second report 376, associated with the first sensing operation, data corresponding to the ten paths (e.g., identified during performance of the first sensing operation). Since core network 130 receives first report 376 and second report 376 that include non-duplicative data, computational resources of core network 130 are conserved, since duplicative data is not processed or stored to identify the non-duplicative data.

In the second implementation in which configuration 372 indicates aggregation across resources, network entity 340 may fuse data associated with detected path for each resource (e.g., each beam of transmitted scan signal 374) and may include the aggregated data in report 376. Referring to FIGS. 4 and 5, rather than generating a report for each beam 402-418 and transmitting the associated report 376 to core network 130 on a per beam basis, network entity 340 may be configured to aggregate data from beams 402-418 and generate a report, such as report 376, that included aggregated data 502 by fusing data from beams 402-418. While fusing data from beams 402-418 may sacrifice information, data aggregation may reduce computational resources and associated power expended in sensing operations to generate an electromagnetic profile of an environment.

Referring back to FIG. 3, in some implementations, configuration 372 includes aggregation criteria 384 that specify resources, conditions, thresholds, or combinations thereof under which the aggregation is to occur. For example, an aggregation criterion might specify aggregation based on a path distance, may specify resource sets that are to be aggregated, or a combination thereof. To illustrate, the aggregation criterion might specify that data from paths having a distance that is less than or equal to 30 meters are to be aggregated for beams one and two associated with transmitted scan signal 374. Accordingly, in response to identifying a plurality of paths having a distance that is less than or equal to 30 meters and that are associated with beams one and two of transmitted scan signal 374, network entity 340 may aggregate data associated with any such detected paths and may include only such data in report 376. As another example, aggregation criteria 384 may specify that data associated with particular resource sets are to be aggregated without imposing a threshold. For instance, an aggregation criterion of aggregation criteria 384 may specify that data generated based on beams 1-3 are to aggregated with data generated based on beams 5-10. As another example, an aggregation criterion of aggregation criteria 384 may specify that data generated by beams having an angles of five degrees is to be aggregated and that data generated by beams having angles of ten degrees is to be aggregated. Accordingly, network entity 340, implementing such a criterion, may aggregate the associated data and may include such aggregate data in report 376. By aggregating data, a data size of report 376 may be smaller than a data size of a report generated without data aggregation, thereby conserving computational resources.

Accordingly, generation, transmission, receipt, processing, or an combination thereof, of such a report may use fewer computational resources, both by network entity 340 and by core network 130, than for a report that does not include aggregated data. In contrast, while a report containing disaggregated data may consume more computational resources to generate, transmit, receive, or process than a report containing aggregated data, a report containing disaggregated data may be more accurate and precise than a report containing aggregated data.

The first implementation, in which the network entity reports data corresponding to any detected objects per beam, and the second implementation, in which the network entity aggregates data across beams and includes the aggregated data in a report, are not mutually exclusive. In particular, the network entity may be configured to apply the first implementation when an accurate and precise electromagnetic profile of an environment would be advantageous. In contrast, when less accuracy and precision are needed, the network entity may be configured to apply the second implementation. For instance, during certain timeframes, such as during certain days or times of a day, a network entity, such as network entity 340, may apply the first implementation, while during other days or times of a day, the network entity may apply the second implementation. To elaborate, in a warehouse environment and during hours of the day when objects are anticipated to be moved into warehouse, the network entity (e.g., network entity 340) may be configured to apply the first implementation so that an accurate and precise electromagnetic profile of the warehouse may be generated. However, during hours of the day when the numbers and types of objects present in the warehouse are anticipated to be static, the network entity may be configured to apply the second implementation.

In some implementations, a configuration, such as configuration 372, may include path characteristics 386 regardless of whether reporting format 382 indicates aggregation. A network entity, such as network entity 340, may process data associated with paths identified during one or more sensing operations based on path characteristics 386, which may include a reference signal receive power per path (RSRP) threshold value, an RSRP per path (RSRPP), a signal to noise ratio (SNR) threshold value, or a combination thereof. For example, path characteristics 386 may include a minimum RSRP per path such that, for data associated with a path to be included in report 376, the path must satisfy the RSRP threshold value, the SNR threshold value, or both.

Moreover, in some implementations, a configuration, such as configuration 372, may include other instructions to indicate, to a network entity, such as network entity 340, the types of sensing data to include in a report, such as report 376. For instance, configuration 372 may indicate, to a network entity, to include spectral characteristics associated with data corresponding to each path. Spectral characteristics may include RSRP values associated with a path, SNR values associated with a path, other electromagnetic characteristics of the path, or a combination thereof. To illustrate, when a network entity (e.g., processor 302 of network entity 340) aggregates data based on a reporting format, such as reporting format 382, the network entity may generate and report aggregated spectral characteristic values, such as aggregated RSRP values or aggregated SNR values, associated with the aggregated data. Additionally or alternatively, the network entity may include, in report 376, a mean, a median, a maximum, a minimum, or a combination thereof of RSRP values, SNR values, or other spectral characteristics associated with data corresponding to aggregated paths. As another example, when data is disaggregated (e.g., data is reported per path), the network entity may report RSRP values per path, SNR values per path, or other spectral characteristic data per path.

As described with reference to FIG. 3, the present disclosure provides techniques for supporting performance of a sensing operation in an environment. The described techniques may enhance tracking of an object in an environment by facilitating generation of electromagnetic profiles of an environment, especially over periods of time. Additionally, by aggregating data associated with particular paths in some cases in which less accurate and less precise information is acceptable, computational resources and associated power may be conserved. Similarly, by being able to transition to a disaggregated reporting protocol when more accurate and more precise data is beneficial, the system is configured to adapt to requirements for generation of electromagnetic profiles.

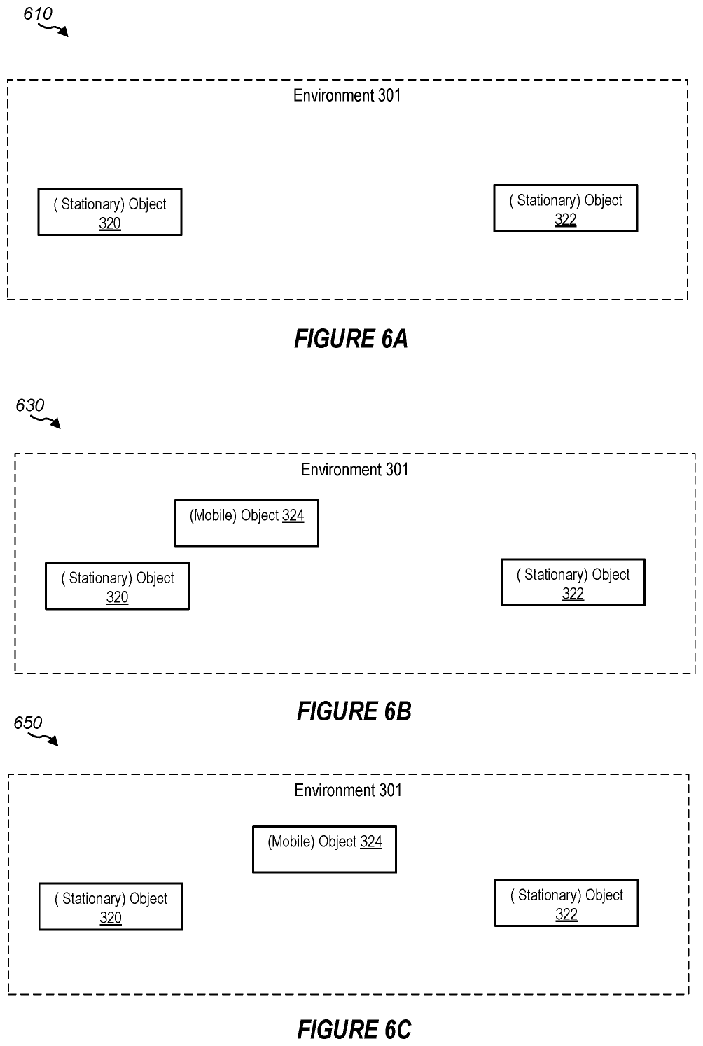

FIGS. 6A-6C show diagrams illustrating an example of an output of a sensing operation performed in an environment according to one or more aspects. Based on one or more reports received from a network entity, a core network may be configured to generate electromagnetic profiles 610, 630, and 650 of an environment, such as environment 301. For example, core network 130 may be configured to generate electromagnetic profiles 610, 630, and 650 of environment 301 based on receiving one or more reports 376 from network entity 340. Electromagnetic profiles 610, 630, and 650 may be generated based on one or more sensing operations performed by the network entity at different timeframes.

Referring to FIG. 6A, electromagnetic profile 610 of environment 301 may indicate a presence of objects 320 and 322 in environment 301. Additionally, electromagnetic profile 610 may indicate a location of objects 320 and 322 within environment 301. In some implementations, core network 130 may generate electromagnetic profile 610 based on one or more reports, such as report 376, transmitted by network entity 340 to core network 130. As explained with reference to FIG. 3, the network entity may generate the one or more reports based on one or more sensing operations. Accordingly, electromagnetic profile 610 may indicate an electromagnetic state of environment 301 at instances of time during which the one or more sensing operations occurred. For example, environment 301 may be a warehouse, and objects 320, 322 may be people working in the warehouse, merchandise present within the warehouse, AGVs operating within the warehouse, robots operating within the warehouse, or any combination thereof. Electromagnetic profile 610 may identify, track, or both objects 320, 322 within the warehouse.

FIG. 6B depicts electromagnetic profile 630 of environment 301. Electromagnetic profile 630 may be based on one or more sensing operations performed by the network entity at different instances of time from the sensing operations performed to generate electromagnetic profile 610. Accordingly, electromagnetic profile 630 may capture changes in a state of environment 301, such as entry, into environment 301 of object 324. Additionally, electromagnetic profile 630 may capture positions of objects 320, 322, and 324 within environment 301. Continuing with the example of the warehouse, when a network entity, such as network entity 340, performs sensing operations to generate electromagnetic profile 630, object 324, such as an AGV, may have entered the warehouse. In this manner, by performing sensing operations over different timeframes and transmitting reports based on the sensing operations to the core network, the core network may be configured to track objects, such as object 324 by identifying when an object enters environment 301 and by identifying a position of the object as it enters environment 301.

FIG. 6C depicts electromagnetic profile 650 of environment 301. Electromagnetic profile 650 may be based on one or more sensing operations performed by the network entity at different instances of time from the sensing operations performed to generate electromagnetic profiles 610 and 630. Accordingly, electromagnetic profile 650 may capture changes in a state of environment 301, such as a movement (e.g., a change in a position of object 324 relative to timeframes associated with electromagnetic profile 630), within environment 301, of object 324. Continuing with the example of the warehouse, when a network entity, such as network entity 340, performs sensing operations to generate electromagnetic profile 650, object 324, such as the AGV, may have changed its location within the warehouse. By performing sensing operations over different timeframes and transmitting reports based on the sensing operations to the core network, the core network may be configured to track objects, such as object 324 by movement of an object, such as object 324, within environment 301.

FIG. 7 shows a diagram illustrating an example of a sensing operation performed in an environment according to one or more aspects. In particular, FIG. 7 illustrates tracking of an object, such as object 324, based on a comparison of electromagnetic profiles 710, 730 representing different electromagnetic states of environment 301 at different timeframes t₀ and t₁. A device, such as core network 130, may generate electromagnetic profiles 710, 730 representing an electromagnetic profile of environment 301 at a particular instances of time or over particular time sequences, collectively referred to as t₀ and t₁, based on one or more reports received from a network entity, such as network entity 340. The network entity may generate the one or more reports, such as report 376, based on one or more sensing operations performed at different instances of time.

For example, network entity 340 may perform a first sequence of sensing operations over a first time interval, to, and may aggregate the data derived from the first sequence of sensing operations into a first report. Network entity 340 may transmit the first report, such as report 376, to core network 130, which may generate electromagnetic profile 710 based on the first report and that may store electromagnetic profile in memory 364. Electromagnetic profile 710 may indicate or represent a physical layout of environment 301, identifying objects 320, 322 that are or were present in environment 301 at time interval t₀. Subsequently, network entity 340 may perform a second sequence of sensing operations over a second time interval, t₁. For data associated with each beam or resource of a transmitted scan signal, such as transmitted scan signal 374, network entity 340 may generate a separate report, such as report 376, and may transmit a sequence of reports associated with each beam or resource to core network 130. Based on the sequence of reports, processor 362 of core network 130 may generate electromagnetic profile 730. Electromagnetic profile 730 may indicate or represent a physical layout of environment 301 at time interval t₁, identifying objects 320, 322, and 324 present in environment 301 at time interval t₁.

Thereafter, core network 130 may generate comparison 750 by comparing electromagnetic profile 710 and electromagnetic profile 730. Based on the comparison, processor 362 of core network 130 may identify that object 324 entered environment 301 during time interval t₁. By performing comparisons of electromagnetic profiles of environment 301 generated for different time intervals, core network 130 may track objects in environment 301, such as object 324.

FIG. 8 is a flow diagram illustrating an example process 800 that supports performance of a sensing operation according to one or more aspects. Operations of process 800 may be performed by core network 130 described above with reference to FIGS. 1-3 or core network 900 with reference to FIG. 9. For example, operations (also referred to as “blocks”) of process 800 may be performed by core network 130, core network 900, or both to support performance of sensing operations.

In block 802, the core network initiates transmission of a configuration associated with a sensing operation. For example, core network 130 initiates transmission of configuration 372 to network entity 340. Configuration 372 may be associated with one or more sensing operations in which network entity 340 generates and transmits transmitted scan signal 374. Assuming a presence, in environment 301, of one or more objects 320-324, transmitted scan signal 374 may reflect off of a surface of the one or more objects 320-324 as reflected scan signal 378. Reflected scan signal 378 may be received by receiver 318 of network entity 340 in a monostatic sensing arrangement or by a receiver of network entity 330 in a bistatic sensing arrangement. In some implementations, transmitted scan signal 376, reflected scan signal 378, or both may correspond to radio frequency (RF) signals, microwave signals, infrared (IR) signals, or any electromagnetic signals. Network entity 340 may generate report 376 based on the sensing operation, applying configuration information 306 included in configuration 372. Configuration information 306 may include reporting format 382, aggregation criteria 384, path characteristics 386, or a combination thereof.

In block 804, the core network receives, from a network entity, a report based on the sensing operation performed by the network entity and that indicates an electromagnetic profile associated with an environment. For example, core network 130 receives report 376 from network entity 340. Based on report 376, processor 362 of core network 130 may generate an electromagnetic profile of environment 301, indicating a presence of objects 320-324 in environment 301. Core network 130 may store the electromagnetic profile as signature, profile, or comparison 390 in memory 364.

In some implementations, the configuration, such as configuration 372, indicates a format of the report, as reporting format 382. The format, such as reporting format 382, may indicate reporting per resource, such as reporting per resource (e.g., per beam) as described with reference to FIG. 4. Alternatively, the format, such as reporting format 382, may indicate aggregated reporting across a plurality of resources (e.g., aggregated over beams) as explained with reference to FIGS. 4 and 5. A resource may correspond to one or more beams associated with transmitted scan signal 374.

In some implementations, the reporting format that indicates aggregated reporting across a plurality of resources (e.g., beams) further indicates aggregation criteria 384. The aggregation criteria 384 may indicate data from particular paths of a plurality of paths to be aggregated. Aggregation criteria 384 may include distance values, angle values, or the like. For example, data associated with paths satisfying certain threshold distance values may be aggregated, data associated with paths satisfying certain threshold angle values may be aggregated, or combinations thereof.

In some implementations, the configuration, such as configuration 372, further indicates a characteristic for a path to be included in the report, such as report 376. A path may be associated with a distance between a network entity, such as network entity 340, and an object, such as any one or more of objects 320-324 in environment 301, an angle between a beam of a resource, such a beam associated with transmitted scan signal 374 deployed to perform a sensing operation, and the one or more objects, or a combination thereof.

In some implementations, the characteristic for the path to be included in the report may indicate a threshold value associated with a reference signal receive power (RSRP) per path (an RSRPP), a signal to noise ratio (SNR) per path, a distance of the path, or a combination thereof. In some implementations, in response to satisfying the threshold, data associated with the path may be included in the report.

In some implementations, an electromagnetic profile indicates an RF profile of the environment (e.g., environment 301), a physical layout of the environment, multipath characterization of the environment, or a combination thereof. For instance and referring to FIGS. 6A-6C, electromagnetic profiles 610, 630, and 650 may indicate a position of objects 320-324 in environment 301.

In some implementations, the core network, such as processor 362 of core network 130, may be configured to identify a target in the environment, such as environment 301, based on a report, such as report 376. The target may include or correspond to one or more objects in the environment, such as any one or more of objects 320-324. For example, the target may include a stationary object, such as objects 320, 322, positioned within the environment, a mobile object, such as object 324, within the environment, or a combination thereof.

In some implementations, the core network, such as processor 362 of core network 362, may receive a second report, such as report 376, generated by the network entity, such as network entity 340 or network entity 330. The second report may be generated based on a second sensing operation performed by the network entity at a second time (e.g., a second interval of time) that is distinct from a first time (e.g., a first interval of time) during which a first sensing operation was performed that is associated with a first report. The core network may be configured to generate a result based on a comparison using the first report and the second report, as explained with reference to FIG. 7. Additionally, the core network may be configured to identify a target (e.g., object 324) based on the result of the comparison.

FIG. 9 is a block diagram of an example core network 900 that supports performance of a sensing operation according to one or more aspects. Core network 900 may be configured to perform operations, including the blocks of a process described with reference to FIG. 8. In some implementations, core network 900 includes the structure, hardware, and components shown and described with reference to UE 115 of FIGS. 1 and 2. For example, core network 900 includes controller 280, which operates to execute logic or computer instructions stored in memory 282, as well as controlling the components of core network 900 that provide the features and functionality of core network 900. Core network 900, under control of controller 280, transmits and receives signals via wireless radios 901a-r and antennas 252a-r. Wireless radios 901a-r include various components and hardware, as illustrated in FIG. 2 for UE 115, including modulator and demodulators 254a-r. MIMO detector 256, receive processor 258, transmit processor 264, and TX MIMO processor 266. Additionally or alternatively, while not depicted in FIG. 9, core network 900 may include wired connections to establish wired links, such as via a backhaul with one or more network devices.

As shown, memory 282 may include profile information 990 and communication logic 903. Profile information 990 may include or correspond to profile information 390. Communication logic 903 may be configured to enable communication between core network 900 and one or more other devices. Core network 900 may receive signals from or transmit signals to one or more network entities, such as base station 105 of FIGS. 1-2, UE 115 of FIGS. 1-2, or a network entity as illustrated in FIG. 11. Additionally, core network 900 may include management function (MF) 905 that may include or correspond to a sensing management function (SnMF) as described with reference to FIG. 1.

FIG. 10 is a flow diagram illustrating an example process 1000 that supports performance of a sensing operation according to one or more aspects. Operations of process 1000 may be performed by a network entity, such as by base station 105 described above with reference to FIGS. 1-2, UE 115 describe above with reference to FIGS. 1-2, or a network entity as described above with reference to FIG. 11. For example, example operations of process 1000 may enable a network entity, such as base station 105, UE 115, or both to support performance of a sensing operation.

At block 1002, the network entity receives a configuration associated with a sensing operation. For example, network entity 340 receives configuration 372. Configuration 372 may include reporting format 382, indicating whether data generated based on a sensing operation is to be reported per beam, as described with reference to FIG. 4, or whether data is to be aggregated over a plurality of beams, as described with reference to FIG. 5. Additionally, configuration 372 may include aggregation criteria 384, indicating mechanisms or criteria for aggregating the data. Further, configuration 386 pay include path characteristics, indicating parameters for including data, associated with paths, in a report, such as report 376.

At block 1004, the network entity initiates transmission of a report based on the sensing operation performed by the network entity and that indicates an electromagnetic profile associated with an environment. For instance, network entity 340 initiates transmission of report 376 based on the sensing operation performed by network entity 340. Report 376 may indicate an electromagnetic profile associated with an environment, such as environment 301.

In some implementations, the network entity, such as network entity 340, performs a sensing operation. As part of the sensing operation, processor 302 of network entity 340 may initiate transmission of transmitted scan signal 374. The scan signal, such as transmitted scan signal 374, may include or correspond to a RF signal, a microwave signal, an infrared (IR) signa, or other electromagnetic signal. Transmitted scan signal 374 may include or correspond to one or more beams transmitted by an antenna array of transmitter 316. For instance, each antenna of a multiple input multiple output (MIMO) antenna array may be configured to emit a beam of transmitted scan signal 374 in a different physical direction. The one or more beams of transmitted scan signal 374 may impinge upon a surface of one or more objects, such as object 322-324, in an environment, such as environment 301. Accordingly, such one or more beams of transmitted scan signal 374 may be reflected, by the surface of the object, as one or more beams of reflected scan signal 378. In this manner, the network entity, such as network entity 340, may identify an object, such as one or more of objects 322-324, positioned within the environment based on the sensing operation. Additionally, the network entity, such as network entity 340, may determine a path to the object. The path may correspond to a direction of the object relative to the network entity, a distance separating the object and the network entity, or both.

In some implementations, the configuration, such as configuration 372, indicates a format of the report, such as report 376, via reporting format 382, which may be stored in memory 304 of network entity 340. For example, the format (e.g., reporting format 382) may indicate reporting per resource as explained more fully with reference to FIG. 4, aggregated reporting across a plurality of resources as explained more fully with reference to FIG. 5, or a combination thereof. The resource may correspond to one or more beams of a scan signal, such as transmitted scan signal 374, to one or more beams of reflected scan signal 378, or a combination thereof.

In some implementations, the network entity, such as processor 302 of network entity 340, is configured to generate a report, such as report 376. To generate the report, processor 302 of network entity 340 may identify one or more paths per resource, and may further identify data associated with the one or more paths. The data associated with the one or more paths may include or correspond to measurement data 387.

In some implementations, the network entity, such as network entity 340, is configured to generate a report, such as report 376, by identifying a plurality of paths per resource. Network entity 340 may compare paths of the plurality of paths. For instance, network entity 340 may compare data associated with paths of the plurality of paths, such as measurement data 397. Based on this comparison, network entity 340 may identify any unique paths among the paths based on comparison of the paths. For example, a first distance measurement associated with a first path may be different from a second distance measurement associated with a second path. Accordingly, network entity 340 may identify the first path as being distinct from the second path based on the distance measurement. In contrast, a third distance measurement associated with a third path may be the same as a fourth distance measurement associated with a fourth path. In such a case, network entity 340 may be configured to compare other measurement data 397 associated with the third and fourth paths, such as angle measurement data, to determine whether the third path is distinct from the fourth path. If measurement data 387 (e.g., distance measurements, angle measurements, etc.) associated with the third path and the fourth path are identical, then network entity 340 may determine that the third path is identical to the fourth path and may conserve computational resources (e.g., memory) and power by only including measurement data 387 in report 376 that corresponds to one of the third path or the fourth path, but not both. Therefore, network entity 340 may identify data corresponding to each unique path.

In some implementations, to identify the data, network entity 340 is configured to identify one or more paths that satisfy a RSRP threshold value, a SNR threshold value, or both. Additionally, the report, such as report 376, generated by network entity 340 may indicate the one or more paths that satisfy the RSRP threshold value, the SNR threshold value, or both.

In some implementations, when the format, such as reporting format 382, indicates the aggregated report, the configuration, such as configuration 372, may further indicate one or more parameters for generation of the report, such as report 376. In particular, to generate the report, network entity 340 may be configured to aggregate, based on the one or more parameters (e.g., aggregation criteria 384), data corresponding to paths identified by one or more scan signals, such as transmitted scan signal 374, reflected scan signal 378, or both.

In some implementations, the one or more parameters indicate one or more clusters of paths. For example, aggregation criteria 384 may indicate that data associated with paths corresponding to beams 1, 3, and 5 of transmitted scan signal 374 are to be aggregated. Accordingly, in such case, the data associated with each path of a cluster of the one or more clusters of paths is aggregated. For instance, the network entity 340 may aggregate data associated with beams 1, 3, and 5, combining such data in report 376.

In some implementations, the one or more parameters include spectral characteristics such that the data corresponding to paths that satisfy the spectral characteristics are aggregated. The spectral characteristics may include a distance between the network entity and an object in the environment, an angle of the path relative to the network entity, or a combination thereof.

In some implementations, to generate the report, the at least one processor is configured to generate a plurality of reports, each report of the plurality of reports generated over a plurality of distinct time intervals. For example, a first set of reports may be associated with a first set of sensing operations performed during a first time period, while a second set of reports may be associated with a second set of sensing operations performed during a second time period that is distinct from the first time period. By generating reports over different time periods and transmitting these reports to a core network, such as core network 130, the core network may be configured to generate electromagnetic profiles of an environment that correspond to different time periods. In this way, an object within an environment may be tracked as explained at least with reference to FIGS. 6A-6C and 7.

FIG. 11 is a block diagram of an example network entity 1100 that supports a sensing operation according to one or more aspects. Network entity 1100 may be configured to perform operations, including the blocks of process 1000 described with reference to FIG. 10. In some implementations, network entity 1100 includes the structure, hardware, and components shown and described with reference to base station 105, UE 115, or both of FIGS. 1-2. For example, network entity 1100 may include controller 240, which operates to execute logic or computer instructions stored in memory 242, as well as controlling the components of network entity 1100 that provide the features and functionality of network entity 1100. Network entity 1100, under control of controller 240, transmits and receives signals via wireless radios 1101a-t and antennas 234a-t. Wireless radios 1101a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include configuration information 1106 and communication logic 1103. Configuration information 1106 may include or correspond to configuration information 306. Communication logic 1103 may be configured to enable communication between network entity 1100 and one or more other devices. Network entity 1100 may receive signals from or transmit signals to one or more base stations 105, one or more UES 115, one or more core networks 130, or any combination thereof, as described with reference to FIGS. 1-3.

It is noted that one or more blocks (or operations) described with reference to FIGS. 8 and 10 may be combined with one or more blocks (or operations) described with reference to another of the figures. For example, one or more blocks (or operations) of FIG. 8 may be combined with one or more blocks (or operations) of FIG. 10 and vice versa. As another example, one or more blocks associated with FIGS. 8, 10, or both may be combined with one or more blocks (or operations) associated with FIGS. 1-3. Additionally, or alternatively, one or more operations described above with reference to FIGS. 1-3 may be combined with one or more operations described with reference to FIG. 9 or 11.

In one or more aspects, techniques for supporting performance of a sensing operation may include additional aspects, such as any single aspect or any combination of aspects described below or in connection with one or more other processes or devices described elsewhere herein. In a first aspect, techniques for supporting performance of a sensing operation may include initiating transmission of a configuration associated with a sensing operation. The techniques may further include receiving, from a network entity, a report based on the sensing operation performed by the network entity and that indicates an electromagnetic profile associated with an environment. In some examples, the techniques in the first aspect may be implemented in a method or process. In some other examples, the techniques of the first aspect may be implemented in a communication device, which may include a network or a component of a network, a core network or a component of a core network, a management function or a component of a management function, a server, or a component of a server. For example, the techniques may include or correspond to a method of communication performed by a network. In some examples, the communication device may include at least one processing unit or system (which may include an application processor, a modem or other components) and at least one memory device coupled to the processing unit. The processing unit may be configured to perform operations described herein with respect to the communication device. In some examples, the memory device includes a non-transitory computer-readable medium having program code stored thereon that, when executed by the processing unit, is configured to cause the communication device to perform the operations described herein. Additionally, or alternatively, the communication device may include an interface (e.g., a communication interface) that includes a transmitter, a receiver, or a combination thereof. Additionally, or alternatively, the communication device may include one or more means configured to perform operations described herein.

In a second aspect, in combination with the first aspect, the configuration indicates a format of the report.

In a third aspect, in combination with the second aspect, the format indicates reporting per resource, aggregated reporting across a plurality of resources, or a combination thereof.

In a fourth aspect, in combination with the third aspect, the resource corresponds to a scan signal.

In a fifth aspect in combination with the fourth aspect, the format that indicates the aggregated reporting across the plurality of resources further indicates an aggregation criteria.

In a sixth aspect, in combination with the fifth aspect, the aggregation criteria indicates that a plurality of paths is to be aggregated.

In a seventh aspect, in combination with one or more of the first aspect through the sixth aspect, the configuration further indicates a characteristic for a path to be included in the report.

In an eighth aspect, in combination with the seventh aspect, the path is associated with a distance between the network entity and an object within the environment, an angle between a beam of a resource deployed to perform the sensing operation and the object, or a combination thereof.

In a ninth aspect, in combination with the eighth aspect, the characteristic indicates a threshold associated with an RSRP, an RSRPP, an SNR, a distance of the path, or a combination thereof. In some implementations, in the ninth aspect, in response to satisfying the threshold, data associated with the path is included in the report.

In a tenth aspect, in combination with one or more of the first aspect through the ninth aspect, the electromagnetic profile indicates an RF profile of the environment, a physical layout of the environment, or a combination thereof.

In an eleventh aspect, in combination with the tenth aspect, the method further comprises the techniques further include identifying a target in the environment based on the report.

In a twelfth aspect, in combination with the eleventh aspect, the target includes a stationary object positioned within the environment.

In a thirteenth aspect, in combination with the eleventh aspect or the twelfth aspect, the target includes a mobile object within the environment.

In a fourteenth aspect, in combination with one or more of the first aspect through the thirteenth aspect, the techniques further include receiving a second report generated by the network entity.

In a fifteenth aspect, in combination with the fourteenth aspect, the report generated by the network entity based on the sensing operation performed at a first time.

In a sixteenth aspect, in combination with the sixteenth aspect, the second report generated based on a second sensing operation performed by the network entity at a second time.

In a seventeenth aspect, in combination with the sixteenth aspect, the first time is different from the second time.

In an eighteenth aspect, in combination with the seventeenth aspect, the techniques further include generating a result based on a comparison using the report and the second report.

In a nineteenth aspect, in combination with the eighteenth aspect, the techniques further include identifying a target based on the result of the comparison.

In one or more aspects, techniques for supporting performance of a sensing operation may include additional aspects, such as any single aspect or any combination of aspects described below or in connection with one or more other processes or devices described elsewhere herein. In a twentieth aspect, techniques for supporting performance of a sensing operation may include receiving a configuration associated with a sensing operation. The techniques may further include initiating transmission of a report based on the sensing operation performed by the network entity and that indicates an electromagnetic profile associated with an environment. In some examples, the techniques in the twentieth aspect may be implemented in a method or process. In some other examples, the techniques of the twentieth aspect may be implemented in a communication device, which may include a network or a component of a network, a core network or a component of a core network, a management function or a component of a management function, a server, or a component of a server. For example, the techniques may include or correspond to a method of communication performed by a network. In some examples, the communication device may include at least one processing unit or system (which may include an application processor, a modem or other components) and at least one memory device coupled to the processing unit. The processing unit may be configured to perform operations described herein with respect to the communication device. In some examples, the memory device includes a non-transitory computer-readable medium having program code stored thereon that, when executed by the processing unit, is configured to cause the communication device to perform the operations described herein. Additionally, or alternatively, the communication device may include an interface (e.g., a communication interface) that includes a transmitter, a receiver, or a combination thereof. Additionally, or alternatively, the communication device may include one or more means configured to perform operations described herein.

In a twenty-first aspect, in combination with the twentieth aspect, the techniques further include performing a sensing operation.

In a twenty-second aspect, in combination with the twenty-first aspect, the techniques further include identifying an object positioned within the environment based on the sensing operation.

In a twenty-third aspect, in combination with the twenty-second aspect, the techniques further include determining a path to the object.

In a twenty-fourth aspect, in combination with the twenty-third aspect, the path corresponds to a direction of the object relative to the network entity and a distance separating the object and the network entity.

In a twenty-fifth aspect, in combination with one or more of the twentieth aspect through the twenty-fourth aspect, the configuration indicates a format of the report.

In a twenty-sixth aspect, in combination with the twenty-fifth aspect, the format indicates reporting per resource, aggregated reporting across a plurality of resources, or a combination thereof.

In a twenty-seventh aspect, in combination with the twenty-sixth aspect, the resource corresponds to a scan signal.

In a twenty-eighth aspect, in combination with the twenty-seventh aspect, the techniques further include generating the report.

In a twenty-ninth aspect, in combination with the twenty-eighth aspect, to generate the report, the techniques further include identifying one or more paths per resource.

In a thirtieth aspect, in combination with the twenty-ninth aspect, to generate the report the techniques further include identifying data associated with the one or more paths.

In a thirty-first aspect, in combination with twenty-seventh aspect, the techniques further include generating the report.

In a thirty-second aspect, in combination with the thirty-first aspect, to generate the report, the techniques further include identifying a plurality of paths per resource.

In a thirty-third aspect, in combination with the thirty-second aspect, to generate the report, the techniques further include comparing paths of the plurality of paths.

In a thirty-fourth aspect, in combination with the thirty-third aspect, to generate the report, the techniques further include identifying any unique paths among the paths based on comparison of the paths.

In a thirty-fifth aspect, in combination with the thirty-fourth aspect, to generate the report, the techniques further include identifying data corresponding to each unique path.

In a thirty-sixth aspect, in combination with the thirtieth aspect, to identify the data, the techniques further include identifying one or more paths that satisfy an RSRP threshold value, an SNR threshold value, or both.

In a thirty-seventh aspect, in combination with the thirty-sixth aspect, the report indicates the one or more paths that satisfy the RSRP threshold value, the SNR threshold value, or both.

In a thirty-eighth aspect, in combination with the twenty-seventh aspect, when the format indicates the aggregated reporting, the configuration further indicates one or more parameters for generation of the report.

In a thirty-ninth aspect, in combination with the thirty-eighth aspect, when the format indicates the aggregated reporting, generating the report includes aggregating, based on the one or more parameters, data corresponding to paths identified by one or more scan signals.

In a fortieth aspect, in combination with the thirty-ninth aspect, when the format indicates the aggregated reporting, the report includes the data.

In a forty-first aspect, in combination with the fortieth aspect, the one or more parameters indicate one or more clusters of paths.

In a forty-second aspect, in combination with the forty-first aspect, the data associated with each path of a cluster of the one or more clusters of paths is aggregated.

In a forty-third aspect, in combination with the forty-second aspect, the one or more parameters include spectral characteristics such that the data corresponding to paths that satisfy the spectral characteristics are aggregated.

In a forty-fourth aspect, in combination with the forty-third aspect, the spectral characteristics include a distance between the network entity and an object in the environment, an angle of the path relative to the network entity, or a combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-11 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A network configured to support one or more sensing operations, the network including:
at least one processor; and
a memory coupled to the at least one processor, wherein the at least one processor is configured to:
initiate transmission of a configuration associated with a sensing operation; and
receive, from a network entity, a report based on the sensing operation performed by the network entity and that indicates an electromagnetic profile associated with an environment.

2. The network of claim 1, wherein:
the configuration indicates a format of the report,
the format indicates reporting per resource, aggregated reporting across a plurality of resources, or a combination thereof, and
the resource corresponds to a scan signal.

3. The network of claim 2, wherein:
the format that indicates the aggregated reporting across the plurality of resources further indicates an aggregation criteria, and
the aggregation criteria indicates that a plurality of paths is to be aggregated.

4. The network of claim 1, wherein:
the configuration further indicates a characteristic for a path to be included in the report, and
the path is associated with a distance between the network entity and an object within the environment, an angle between a beam of a resource deployed to perform the sensing operation and the object, or a combination thereof.

5. The network of claim 4, wherein the characteristic indicates a threshold associated with a reference signal receive power (RSRP), a signal to noise ratio (SNR), an RSRP per path (RSRPP), a distance of the path, or a combination thereof, and wherein, in response to satisfying the threshold, data associated with the path is included in the report.

6. The network of claim 1, wherein the electromagnetic profile indicates a radio frequency (RF) profile of the environment, a physical layout of the environment, multipath characterization of the environment, or a combination thereof, and wherein the at least one processor is further configured to:
identify a target in the environment based on the report, and wherein:
the target includes a stationary object positioned within the environment,
the target includes a mobile object within the environment, or
a combination thereof.

7. The network of claim 1, wherein the at least one processor is further configured to:
receive a second report generated by the network entity, the report generated by the network entity based on the sensing operation performed at a first time, the second report generated based on a second sensing operation performed by the network entity at a second time, and the first time is different from the second time;
generate a result based on a comparison using the report and the second report; and
identify a target based on the result of the comparison.

8. A method, performed by a network, to support one or more sensing operations, the method comprising:
initiating transmission of a configuration associated with a sensing operation; and
receiving, from a network entity, a report based on the sensing operation performed by the network entity and that indicates an electromagnetic profile associated with an environment.

9. The method of claim 8, wherein:
the configuration indicates a format of the report,
the format indicates reporting per resource, aggregated reporting across a plurality of resources, or a combination thereof, and
the resource corresponds to a scan signal.

10. The method of claim 9, wherein:
the format that indicates the aggregated reporting across the plurality of resources further indicates an aggregation criteria, and
the aggregation criteria indicates that a plurality of paths is to be aggregated.

11. The method of claim 8, wherein:
the configuration further indicates a characteristic for a path to be included in the report, and
the path is associated with a distance between the network entity and an object within the environment, an angle between a beam of a resource deployed to perform the sensing operation and the object, or a combination thereof.

12. The method of claim 11, wherein the characteristic indicates a threshold associated with a reference signal receive power (RSRP), a RSRP per path (RSRPP), a signal to noise ratio (SNR), a distance of the path, or a combination thereof, and wherein, in response to satisfying the threshold, data associated with the path is included in the report.

13. The method of claim 8, wherein the electromagnetic profile indicates a radio frequency (RF) profile of the environment, a physical layout of the environment, or a combination thereof, and wherein the method further comprises:
identifying a target in the environment based on the report, and
wherein:
the target includes a stationary object positioned within the environment,
the target includes a mobile object within the environment, or
a combination thereof.

14. The method of claim 8, further comprising:
receiving a second report generated by the network entity, the report generated by the network entity based on the sensing operation performed at a first time, the second report generated based on a second sensing operation performed by the network entity at a second time, and the first time is different from the second time;
generating a result based on a comparison using the report and the second report; and
identifying a target based on the result of the comparison.

15. A network entity configured to perform one or more sensing operations, the network entity including:
at least one processor; and
a memory coupled to the at least one processor, wherein the at least one processor is configured to:
receive a configuration associated with a sensing operation; and
initiate transmission of a report based on the sensing operation performed by the network entity and that indicates an electromagnetic profile associated with an environment.

16. The network entity of claim 15, wherein the at least one processor is further configured to:
perform a sensing operation;
identify an object positioned within the environment based on the sensing operation; and
determine a path to the object, the path corresponds to a direction of the object relative to the network entity and a distance separating the object and the network entity.

17. The network entity of claim 15, wherein:
the configuration indicates a format of the report,
the format indicates reporting per resource, aggregated reporting across a plurality of resources, or a combination thereof, and
the resource corresponds to a scan signal.

18. The network entity of claim 17, wherein the at least one processor is further configured to generate the report, and wherein, to generate the report, the at least one processor is configured to:
identify one or more paths per resource, and
identify data associated with the one or more paths.

19. The network entity of claim 17, wherein the at least one processor is further configured to generate the report, and wherein, to generate the report, the at least one processor is configured to:
identify a plurality of paths per resource,
compare paths of the plurality of paths,
identify any unique paths among the paths based on comparison of the paths, and
identify data corresponding to each unique path.

20. The network entity of claim 18, wherein:
to identify the data, the at least one processor is configured to identify one or more paths that satisfy a RSRP threshold value, a SNR threshold value, or both, and
the report indicates the one or more paths that satisfy the RSRP threshold value, the SNR threshold value, or both.

21. The network entity of claim 17, wherein, when the format indicates aggregated reporting:
the configuration further indicates one or more parameters for generation of the report;
to generate the report, the at least one processor is configured to aggregate, based on the one or more parameters, data corresponding to paths identified by one or more scan signals; and
the report includes the data.

22. The network entity of claim 21, wherein:
the one or more parameters indicate one or more clusters of paths, and wherein the data associated with each path of a cluster of the one or more clusters of paths is aggregated,
the one or more parameters include spectral characteristics such that the data corresponding to paths that satisfy the spectral characteristics are aggregated, and
the spectral characteristics include a distance between the network entity and an object in the environment, an angle of the path relative to the network entity, or a combination thereof.

23. A method, performed by a network entity, to support one or more sensing operations, the method comprising:
receiving a configuration associated with a sensing operation; and
initiating transmission of a report based on the sensing operation performed by the network entity and that indicates an electromagnetic profile associated with an environment.

24. The method of claim 23, further including:
performing a sensing operation;
identifying an object positioned within the environment based on the sensing operation; and
determining a path to the object, the path corresponds to a direction of the object relative to the network entity and a distance separating the object and the network entity.

25. The method of claim 23, wherein:
the configuration indicates a format of the report,
the format indicates reporting per resource, aggregated reporting across a plurality of resources, or a combination thereof, and
the resource corresponds to a scan signal.

26. The method of claim 25, further comprising generating the report, wherein generating the report includes:
identifying one or more paths per resource, and
identifying data associated with the one or more paths.

27. The method of claim 25, further including:
generating the report,
wherein generating the report includes:
identifying a plurality of paths per resource,
comparing paths of the plurality of paths,
identifying any unique paths among the paths based on comparison of the paths, and
identifying data corresponding to each unique path.

28. The method of claim 26, wherein:
identifying the data includes identifying one or more paths that satisfy a RSRP threshold value, a SNR threshold value, or both, and
the report indicates the one or more paths that satisfy the RSRP threshold value, the SNR threshold value, or both.

29. The method of claim 25, wherein, when the format indicates the aggregated reporting:
the configuration further indicates one or more parameters for generation of the report;
generating the report includes aggregating, based on the one or more parameters, data corresponding to paths identified by one or more scan signals; and
the report includes the data.

30. The method of claim 29, wherein:
the one or more parameters indicate one or more clusters of paths, and wherein the data associated with each path of a cluster of the one or more clusters of paths is aggregated,
the one or more parameters include spectral characteristics such that the data corresponding to paths that satisfy the spectral characteristics are aggregated, and
the spectral characteristics include a distance between the network entity and an object in the environment, an angle of the path relative to the network entity, or a combination thereof.
